(19) United States
(12) Patent Application Publication
(10) Pub. No.: US 2025/0198494 A1
(43) Pub. Date: Jun. 19, 2025

(54) METHODS OF MAKING DISC SPROCKETS AND SPROCKETS

(71) Applicant: GATES CORPORATION, Denver, CO (US)

(72) Inventors: Chris Wilkins, Englewood, CO (US); Elizabeth Amici, Denver, CO (US); Caelyn Rittenhouse, Englewood, CO (US); Jennifer E. Pease, Englewood, CO (US)

(73) Assignee: GATES CORPORATION, Denver, CO (US)

(21) Appl. No.: 18/845,066

(22) PCT Filed: Mar. 3, 2023
(86) PCT No.: PCT/US2023/014518

§ 371 Date: Sep. 9, 2024

Related U.S. Application Data
(60) Provisional application No. 63/317,334, filed on Mar. 7, 2022.

(51) Int. Cl. F16H 55/17; B26F 3/00; F16H 55/06

(52) U.S. Cl. CPC F16H 55/171; B26F 3/004; F16H 55/06

(57) ABSTRACT

Methods of making a sprocket, including a multi-disc sprocket formed by assembling multiple disc sprockets. The methods including using a water jet cutter, optionally with abrasive, to form the disc sprocket. The resulting disc sprocket can have radially outwardly extending teeth. No thermal stress is evident within the sprocket or the disc sprocket, including proximate the teeth.

### CROSS-REFERENCE

This application claims priority to U.S. provisional application 63/317,334 filed Mar. 7, 2022, the entire disclosure of which is incorporated herein by reference for all purposes.

### TECHNICAL FIELD

The present application relates to sprockets, sprocket systems, and methods of making the same. More specifically, the present application relates to methods of making multiple disc sprockets, which are coaxially aligned and secured together to provide a sprocket.

### BACKGROUND

Sprockets can be manufactured using various known methods and technologies. In one example, the sprocket is formed using a die cast method. In such methods, a mold is used to form the specific shape and dimensions of the sprocket, including the tooth profile for the sprocket. Die cast processes are economical and capable of forming very precise tooth profiles. However, as the width of the sprocket being formed increases, it becomes difficult to eject the sprocket from the mold without creating a drafting angle in the tooth profile. Avoiding the creation of a drafting angle is an important factor to the performance of the sprocket, as the existence of a drafting angle will generally lead to a belt tracking sideways on the sprocket. Accordingly, die cast methods are generally not used in the manufacture of larger width sprockets.

For the manufacture of larger width sprockets, sand casting techniques may be used. In such processes, the sprocket is formed without a tooth profile, and then the tooth profile is created in the “blank” sprocket using various machining techniques. Some examples of techniques that can be used to create the tooth profile in the “blank” sprocket include CNC, tooth shaping, and tooth hobbing. However, these techniques can be expensive, time consuming, and may lead to less precise tooth profile formation.

In view of the above, a need exists for new manufacturing methods and configurations for larger width sprockets.

### SUMMARY

This Summary is provided to introduce a selection of concepts in a simplified form that are further described below in the Detailed Description. This Summary, and the foregoing Background, is not intended to identify key aspects or essential aspects of the claimed subject matter. Moreover, this Summary is not intended for use as an aid in determining the scope of the claimed subject matter.

The present disclosure is directed to methods of making a sprocket, including a multi-disc sprocket, by using a water jet cutter. The resulting sprocket can have radially outwardly extending teeth. No thermal stress may be evident within the disc sprocket or sprocket, including proximate the teeth.

These and other aspects of the technology described herein will be apparent after consideration of the Detailed Description and figures herein. It is to be understood, however, that the scope of the claimed subject matter shall be determined by the claims as issued and not by whether given subject matter addresses any or all issues noted in the Background or includes any features or aspects recited in the Summary.

### BRIEF DESCRIPTION OF THE DRAWINGS

Non-limiting and non-exhaustive embodiments of the disclosed technology, including the preferred embodiment, are described with reference to the following figures, wherein like reference numerals refer to like parts throughout the various views unless otherwise specified.

FIG. 1 is a perspective view of a multi-disc sprocket.

FIG. 2 is a cross-sectional side view of the multi-disc sprocket of FIG. 1.

FIG. 3 is a perspective view another multi-disc sprocket.

FIG. 4 is a perspective view of yet another multi-disc sprocket.

FIG. 5 is a step-wise flow chart showing steps for forming a sprocket.

### DETAILED DESCRIPTION

In the following description, reference is made to the accompanying drawing that forms a part hereof and in which is shown by way of illustration at least one specific implementation. The following description provides additional specific implementations. These embodiments are disclosed in sufficient detail to enable those skilled in the art to practice the invention. It is to be understood that other implementations are contemplated and may be made without departing from the scope or spirit of the present disclosure. The following detailed description, therefore, is not to be taken in a limiting sense. While the present disclosure is not so limited, an appreciation of various aspects of the disclosure will be gained through a discussion of the examples, including the figures, provided below. In some instances, a reference numeral may have an associated sub-label consisting of a lower-case letter to denote one of multiple similar components. When reference is made to a reference numeral without specification of a sub-label, the reference is intended to refer to all such multiple similar components.

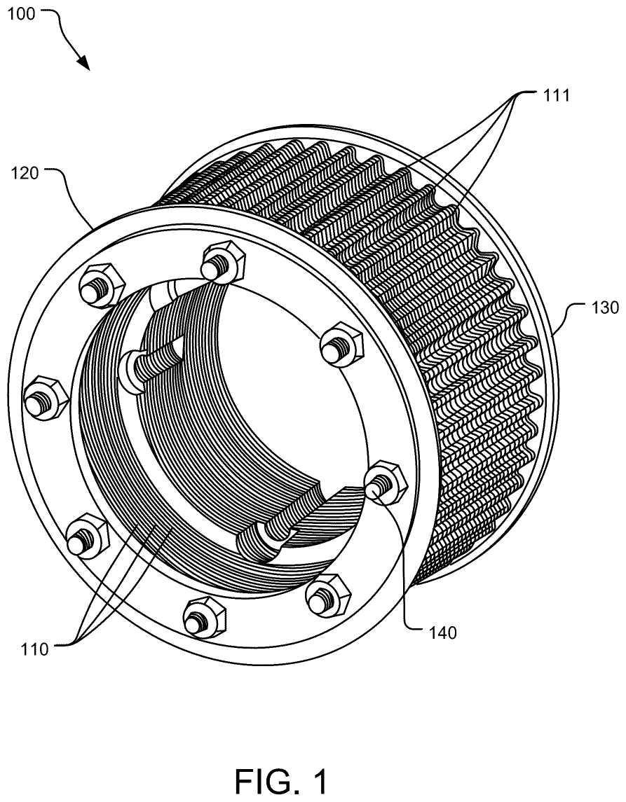

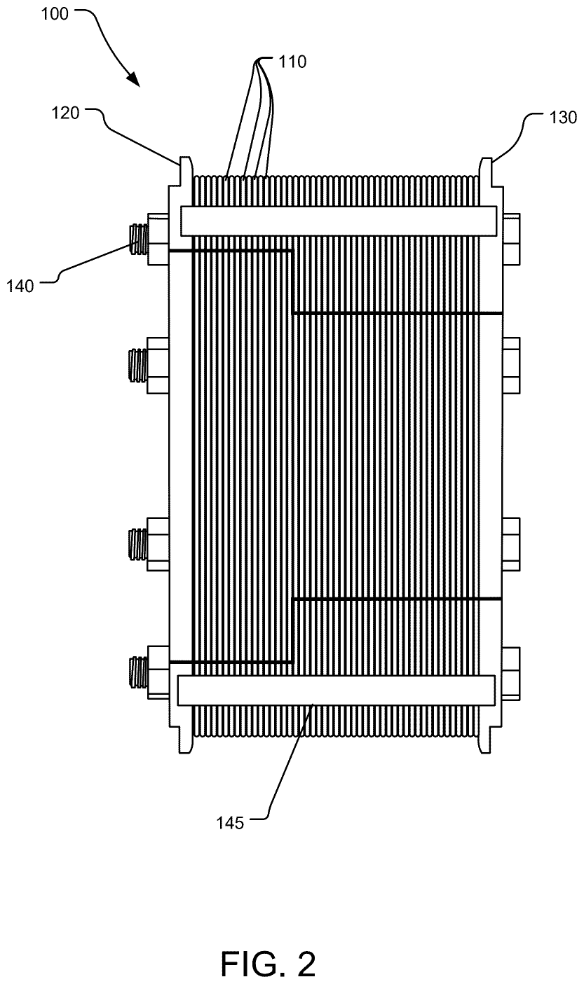

Turning to the figures, a multi-disc sprocket 100 is shown in FIGS. 1 and 2, the multi-disc sprocket 100 generally including a plurality of individual disc sprockets 110 coaxially aligned. In this particular embodiment, the plurality of disc sprockets 110 are sandwiched between a first end flange 120 and a second end flange 130. A plurality of fasteners 112 extend through the first end flange 120, the plurality of individual disc sprockets 110, and the second end flange 130 to thereby secure together these components of the sprocket 100.

Each disc sprocket 110 has a planar, generally annular shaped body, including an inner diameter and an outer diameter. At the outer diameter, each disc sprocket 110 has a tooth profile, i.e., a series of teeth extending radially outwardly and located around the entire circumference of the disc sprocket 110. The outer diameter and the tooth profile (including the size, shape, spacing and number of teeth) of each of the disc sprockets 110 is identical such that the disc sprockets 110 can be aligned to form a plurality of axially aligned teeth 111 that extend the axial width of the sprocket 100.

Each of the disc sprockets 110 also includes a plurality of fastener apertures spaced circumferentially around the disc sprocket 110. The number, spacing and size of these fastener apertures can be identical in each disc sprocket 110 such that the fastener apertures in each disc sprocket 110 can be axially aligned. When aligned, a fastener 140 can be extended through the fastener apertures in each disc sprocket 110 to thereby secure the disc sprockets 110 together. The first end flange 120 and the second end flange 130 can also include fastener apertures aligned with the fastener apertures in the disc sprockets 110 such that the fasteners 140 can also extend through the first end flange 120 and the second end flange 130 and thus secure the first end flange 120 and the second end flange 130 with the disc sprockets 110.

In some embodiments, the fastener apertures are formed in the disc sprockets 110 and the end flanges 120, 130 after the disc sprockets and end flanges have been stacked together and the tooth profiles of each disc sprocket 110 have been aligned. This can help to ensure that the fastener apertures in each component of the sprocket 100 are aligned so as to form an axially straight opening through the width of the sprocket 100, and ensure that the fastener apertures are formed in a location that helps to further ensure the tooth profile of the disc sprockets 110 remains aligned.

Each disc sprocket 110 includes an inner diameter, though the dimensions of the inner diameter may vary between each disc sprocket 110. As shown in FIGS. 1 and 2, a first grouping of disc sprockets 110 located proximate the first end flange 120 has a first inner diameter, while a second grouping of disc sprockets 110 located proximate the second end flange 130 has a second inner diameter that is different than the first inner diameter, in this embodiment, smaller than the first inner diameter. This configuration creates a shelf, shoulder, or lip along the inner axial passage of the multi-disc sprocket 100 as defined by the inner diameters of the disc sprockets 110. In the particular embodiment shown, this shelf, shoulder or lip is approximately centered, located approximately equidistance from the first end flange 120 and the second end flange 130. Such a configuration may be provided such that the inner axial passage may be further shaped such that a bushing may be received within the inner axial passage.

The specific dimensions of the disc sprockets 110, including the inner diameter, the outer diameter, and the width, are generally not limited. Similarly, the specific tooth profile used (including size, shape, spacing and number of teeth) is generally not limited. All of the parameters can be adjusted based on the specific end use application of the sprocket 100. In some embodiments, however, the axial width of each disc sprocket 110 is relatively small such that relatively thin disc sprockets 110 are provided.

The specific number of disc sprockets 110 used in the sprocket 100 is also generally not limited. The specific number of disc sprockets 110 used in the sprocket 100 will generally depend on the desired final axial width of the sprocket 100, with more disc sprockets 110 being used to accomplish larger width sprockets 100. In some embodiments, the number of disc sprockets 110 included in sprocket 100 is 10 or more, 20 or more, 30 or more, 40 or more, or 50 or more.

The first end flange 120 and second end flange 130 generally serve as end caps to the sprocket 100 and sandwich together the plurality of disc sprockets 110 located therebetween. Like disc sprockets 110, the first end flange 120 and the second end flange 130 each have a generally annular shape. As best shown in FIG. 2, the first end flange 120 and second end flange 130 may have an outer diameter that is equal to or greater than the outer diameter of the disc sprockets 110. In some embodiments, the outer diameter of the first end flange 120 and the second end flange 130 may be identical. The axial thickness of the first end flange 120 and second end flange 130 is not limited, though in some embodiments, the axial thickness of the flanges 120, 130 may be greater than the axial thickness of the disc sprockets 110.

As also shown in FIG. 2, the inner diameter of the first end flange 120 is generally similar or identical to the inner diameter of the disc sprockets 110 located proximate the first end flange 120. Similarly, the inner diameter of the second end flange 130 is similar or identical to the inner diameter of the disc sprockets 110 located proximate the second end flange 130. In this configuration, the inner diameter of the first end flange 120 will be larger than the inner diameter of the second end flange 130.

The specific type of fasteners 140 used to secure the components of the sprocket 100 (e.g., the first end flange 120, the disc sprockets 110, and the second end flange 130) is generally not limited. Exemplary fastener types suitable for use in the embodiments described herein include, but are not limited to, bolts, screws, and rivets. In some embodiments, threaded bolts are used. In such embodiments, the threaded bolts include a head at one end, the diameter of the head being larger than the fastener apertures. The threaded bolts are also longer than the axial width of the sprocket 100 (e.g., the combination of the first end flange 120, the disc sprockets 110, and the second end flange 130) such that an end of the threaded bolt opposite the head extends out from the end flange, either the first end flange 120 or the second end flange 130. A nut can then be threaded on the end of the threaded bolt to thereby tighten and secure together the components of the sprocket 100. Regardless of the specific type of fastener used, any number of fasteners can be used to secure together the components of the sprocket 100.

With reference to FIG. 2, the sprocket 100 may further include one or more dwell pins 145. Dwell pins 145 can generally be used to, for example, further ensure that the tooth profiles of the disc sprockets 110 are and remain aligned. Dwell pins 145 generally extend all the way through each of the disc sprockets 110, e.g., via aligned dwell pin openings formed in the disc sprockets 110, and extend at least partially into the first end flange 120 and the second end flange 130. As shown in FIG. 2, either or both first end flange 120 and second end flange 130 can include a recess on their interior side, these recesses being aligned with the dwell pin openings in the disc sprockets 110 so that the dwell pins 145 may extend at least partially into the first end flange 120 and second end flange 130. Any number of dwell pins can be used in the embodiments described herein. In some embodiments, shoulder bolts are used instead of dwell pins.

The axial interior passage of the sprocket 100, defined by the inner diameter, can be configured to receive a bushing therein; a bushing is generally used to secure the sprocket 100 to a shaft, e.g., a rotatable shaft. Any type of bushing can be used, and the shape and dimensions of the interior passage can be adjusted to accommodate any suitable type of bushing. In some embodiments, the bushing present in the interior passage of the sprocket 100 is a taper lock bushing. FIG. 2 shows an embodiment where the interior passage is machined to receive a taper lock bushing. In FIG. 2, and as described previously, a first portion of the disc sprockets 110 have a first inner diameter and a second portion of the disc sprockets 110 have a second inner diameter that is less than the first inner diameter to thereby create a shelf, shoulder, or lip in the interior passage. The interior passage may be further machined to create a gradually narrowing section of the interior passage from the shelf/shoulder/lip to the side of the sprocket 100 having the smaller diameter. This tapering portion of the interior passage is thus configured to receive a taper lock bushing therein.

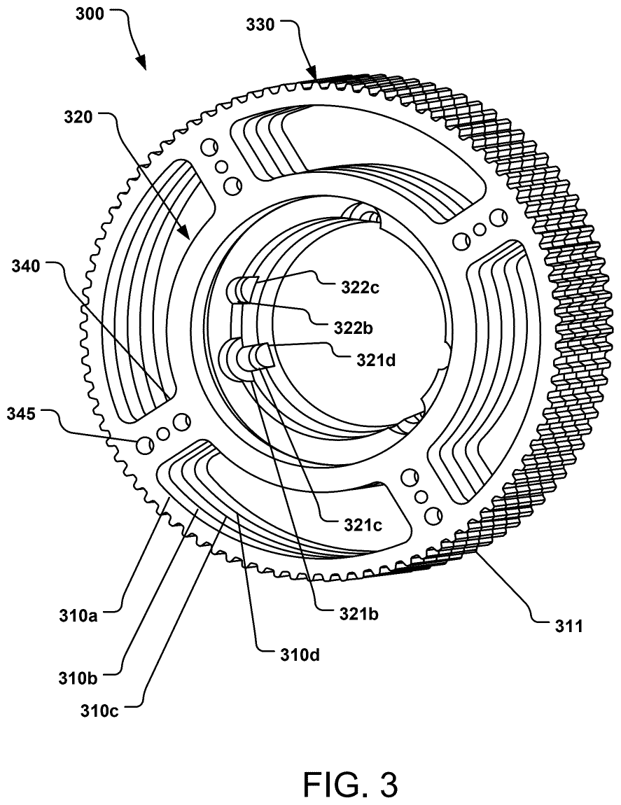

FIG. 3 shows another embodiment of a multi-disc sprocket 300. Similar to the multi-disc sprocket 100 of FIGS. 1 and 2, the sprocket 300 of FIG. 3 includes a plurality of individual disc sprockets 310 coaxially aligned, in this embodiment, only four disc sprockets 310a, 310b, 310c, 310d. Each of the disc sprockets 310 has an inner ring 320 that defines an interior passage having an inner diameter (described below) and outer ring 330 that includes the outwardly extending teeth (described below) and has an outer diameter. Radially extending arms 340 connect the outer ring 330 to the inner ring 320.

Each disc sprocket 310 has a generally annular shape, including the inner diameter defined by the inner ring 320 and the outer diameter defined by the outer ring 330. At the outer diameter, each disc sprocket 310 has a tooth profile, i.e., a series of teeth extending radially outwardly and located around the entire circumference of the disc sprocket 310. The outer diameter and the tooth profile (including the size, shape, spacing and number of teeth) of each of the disc sprockets 310 is identical such that the disc sprockets 310 can be aligned to form a plurality of axially aligned teeth 311 that extend the axial width of the sprocket 300. In this particular embodiment shown, the sprocket 300 does not have end flanges.

The inner diameter of each disc sprocket 310 is not the same. As seen in FIG. 3, the inner diameter of disc sprocket 310a is larger than the diameter of the disc sprockets 310b, 310c, 310d. The inner diameters of the disc sprockets 310b, 310c, 310d are the same, however, the three inner rings 320 of the disc sprockets 310b, 310c, 310d differ. It is noted that the outer diameter of the inner rings 320 of the four disc sprockets 310a, 310b, 310c, 310d is the same.

The inner ring 320 of the second disc sprocket 310b includes five concave indent regions, only two of which are called out in FIG. 3, as concave indent regions 321b, 322b. Each of these indent regions 321b, 322b, etc. extends through the thickness of the disc sprocket 310b.

The inner ring 320 of the third disc sprocket 310c also includes five concave indent regions, only two of which are called out in FIG. 3, as concave indent regions 321c, 322c, respectively aligned with the indent regions 321b, 322b of the second disc sprocket 310b. The concave indent regions 321c, 322c, etc. differ, however, from the indent regions 321b, 322b, etc. of the second disc sprocket 310b. For example, the indent region 321c has a smaller diameter than the aligned indent region 321b, and the indent region 322c does not extend through the disc sprocket 310c but rather is a recess into the disc sprocket 310c.

The inner ring 320 of the fourth disc sprocket 310d has only three concave indent regions, only one of which is called out in FIG. 3 as region 321d, which is a recess into the disc sprocket 310d.

Each of the disc sprockets 310 also includes a plurality of fastener apertures 345 spaced circumferentially around the disc sprocket 310, in this embodiment, the fastener apertures 345 are located on the radial arms 340 connecting the outer ring 330 to the inner ring 320. The number, spacing and size of these fastener apertures 345 can be identical in each disc sprocket 310 such that the fastener apertures in each disc sprocket 310 can be axially aligned. When aligned, a fastener (not shown) can be extended through the fastener apertures 345 in each disc sprocket 310 to thereby secure the disc sprockets 310 together.

The multi-disc sprocket 100 of FIGS. 1 and 2 and the sprocket 300 of FIG. 3 are generally hub-less multi-disc sprockets. In other words, the sprockets 100, 300 are connected or secured to a shaft via a bushing as described previously in relation to the sprocket 100, but which also applies to the sprocket 300. This is contrast to some sprocket configurations which require the sprocket to be connected or secured to a hub, the hub to be secured or connected to a bushing, and the bushing to be secured or connected to the shaft.

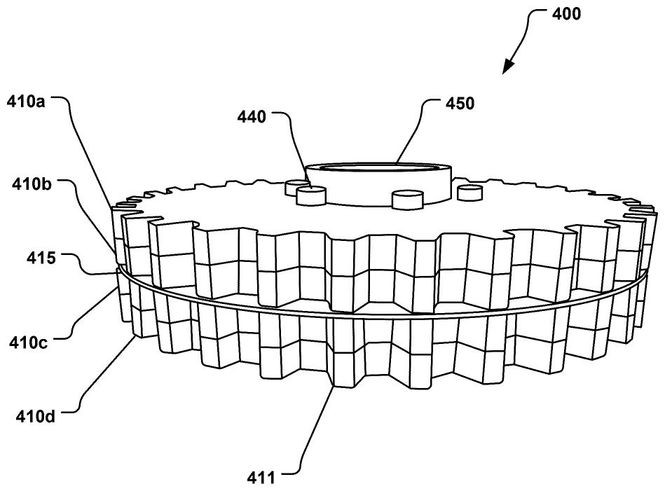

FIG. 4 shows a multi-disc sprocket 400 that includes a hub. Similar to the multi-disc sprocket 100 of FIGS. 1 and 2 and the multi-disc sprocket 300 of FIG. 3, the sprocket 400 of FIG. 4 includes a plurality of individual disc sprockets 410 coaxially aligned, in this embodiment, four disc sprockets 410a, 410b, 410c, 410d. Each of the disc sprockets 410 has a generally annular shape, including an inner diameter and an outer diameter. At the outer diameter, each disc sprocket 410 has a tooth profile, i.e., a series of teeth 411 extending radially outwardly and located around the entire circumference of the disc sprocket 410.

The sprocket 400 includes a flange 415 axially centered, between the disc sprockets 410a, 410b and the disc sprockets 410c, 410d. Each of the disc sprockets 410 and the center flange 415 also includes a plurality of fastener apertures spaced circumferentially around the disc sprocket 410, in this embodiment, proximate the inner diameter. Fasteners 440 extend through the fastener apertures to secure the disc sprockets 410 and the center flange 415 together.

The individual disc sprockets 110 of FIGS. 1 and 2, the disc sprockets 310 of FIG. 3, the disc sprockets 410 of FIG. 4, and any variations thereof, are formed by water jet cutting, with or without an abrasive present in the high-pressure water jet, the abrasive being suspended or not in the water or other fluid. The water jet provides low cost and long-life alternative to conventional sprocket-forming methods, such as stamping and casting. Additionally, the water jet allows for creating of tooth profiles that are difficult or complicated to create with conventional sprocket-forming methods. For example, different pitch profiles can be obtained, as well as undercuts, high amplitude teeth, and/or high frequency teeth. The water jet also allows for accurate formation of fastener apertures and the like.

Water jet cutting is particularly beneficial for forming thick disc sprockets, having a thickness of e.g., 1 inch or more (about 2.5 cm or more), e.g., 1.5 inches or more (about 3.8 cm or more), e.g., 2 inches or more (about 5 cm or more), as use of the water jet creates no heat-induced (thermal) stress in the resulting product. Water jet cutting can, of course, also be used for thinner disc sprockets, where also no thermal stress results in the resulting product.

Water jet cutting, properly controlled, can cut through plate metal with little or no variation in dimension through the thickness of the plate; that is, the cut resulting from the water jet (if so designed) is perpendicular through the thickness of the plate with little or no distortion or angle. Additionally, careful control of the water jet can create a recess partially into the thickness of the plate (see, e.g., concave recesses 322c, 321d in FIG. 3) rather than cutting through the entire thickness of the plate.

After cutting with the water jet, a 2D or 3D scan can be done on the disc sprockets to verify dimensional compliance with the desired standards.

In some embodiments, a planar sheet of metal (e.g., steel, iron) having the same thickness as the desired width of the disc sprockets can be used, and then a plurality of disc sprockets can be cut out of the sheet having the desired shape and dimensions of the disc sprockets. This water jet technique for the formation of disc sprockets is a fast, efficient and cost-effective method for forming a plurality of disc sprockets. Additionally, a single sprocket can be cut from a sheet having the thickness of the desired sprocket width.

The cut disc sprockets and sprockets can be post-processed by any number of follow-up steps. For example, any defects in the disc sprockets or sprockets, particularly the teeth, may be manually filed, e.g., with a metal file. The disc sprockets may be tumbled, e.g., with loose abrasive, to adjust the surface finish (Ra) of the sprocket. The disc sprockets may be sand blasted or bead blasted (e.g., with silica, glass, ceramic). The disc sprockets may be buffed, e.g., with a fine abrasive wheel, a cloth buffing wheel, or the like, to round and soften any sharp edges.

After the cutting of the individual disc sprockets and any follow-up steps (e.g., tumbling, bead blasting, or sand blasting), the disc sprockets are assembled to form a sprocket.

The disc sprockets can be cut from metal plate material, such as aluminum, steel (e.g., carbon steel such as A36, A572, A588, 1045, A516, A514; carbon alloy such as 4130, 4140, 4340), stainless steel, iron, titanium, nickel, copper, brass, bronze, and many other metals and metal alloys.

In one particular embodiment, four disc sprockets (e.g., the disc sprockets 310 of FIG. 3) are cut from A36 plate steel, each disc sprocket 1.5 inches (about 3.8 cm) thick. The four disc sprockets are bolted and pinned together to form a sprocket (e.g., the sprocket 300 of FIG. 3). In another particular embodiment, four disc sprockets (e.g., the disc sprockets 410 of FIG. 4) are cut from A36 plate steel, each disc sprocket 1.5 inches (about 3.8 cm) thick. The four disc sprockets are combined with a flange and bolted together. A hub is inserted and secured to the disc sprockets to form a sprocket (e.g., the sprocket 400 of FIG. 4).

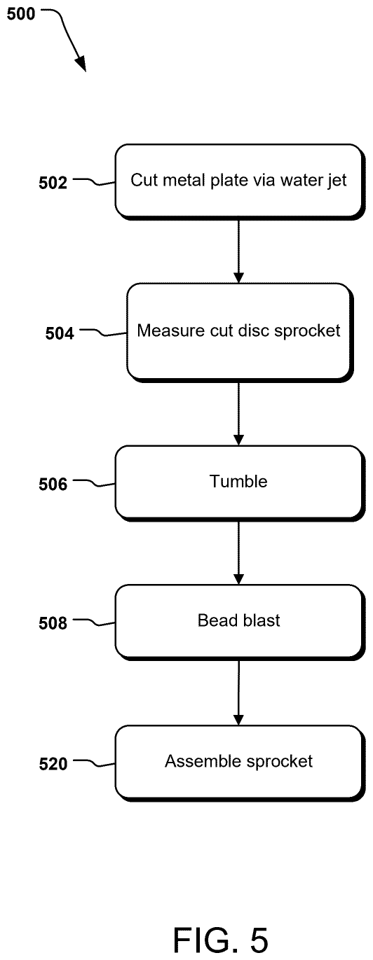

FIG. 5 shows a general method 500 for forming a sprocket, such as the sprocket 100 of FIGS. 1 and 2, the sprocket 300 of FIG. 3, the sprocket 400 of FIG. 4, or any variations thereof. In a first step 502, a metal plate is cut via water jet to the predetermined shape and size for a disc sprocket. The water jet may comprise abrasive in the cutting fluid. In a second step 504, the cut disc sprocket is measured and compared to the desired standard. In an optional third step 506, the disc sprocket is tumbled, e.g., to modify surface finish. In another optional fourth step 508, the disc sprocket is bead blasted, e.g., to modify surface finish. In a fifth step 510, if multiple disc sprockets are cut by step 502 and processed by any or all of steps 504, 506, 508, the multiple disc sprockets are assembled, e.g., with fasteners to form a sprocket. A hub may be included with the sprocket. Multiple disc sprockets may be cut from the same metal plate, or from individual plates.

From the foregoing, it will be appreciated that specific embodiments of the invention have been described herein for purposes of illustration, but that various modifications may be made without deviating from the scope of the invention. Accordingly, the invention is not limited except as by the appended claims.

Although the technology has been described in language that is specific to certain structures and materials, it is to be understood that the invention defined in the appended claims is not necessarily limited to the specific structures and materials described. Rather, the specific aspects are described as forms of implementing the claimed invention. Because many embodiments of the invention can be practiced without departing from the spirit and scope of the invention, the invention resides in the claims hereinafter appended.

Unless otherwise indicated, all number or expressions, such as those expressing dimensions, physical characteristics, etc., used in the specification (other than the claims) are understood as modified in all instances by the term “approximately”. At the very least, and not as an attempt to limit the application of the doctrine of equivalents to the claims, each numerical parameter recited in the specification or claims which is modified by the term “approximately” should at least be construed in light of the number of recited significant digits and by applying rounding techniques. Moreover, all ranges disclosed herein are to be understood to encompass and provide support for claims that recite any and all sub-ranges or any and all individual values subsumed therein. For example, a stated range of 1 to 10 should be considered to include and provide support for claims that recite any and all sub-ranges or individual values that are between and/or inclusive of the minimum value of 1 and the maximum value of 10; that is, all sub-ranges beginning with a minimum value of 1 or more and ending with a maximum value of 10 or less (e.g., 5.5 to 10, 2.34 to 3.56, and so forth) or any values from 1 to 10 (e.g., 3, 5.8, 9.9994, and so forth).

We claim:

1. A method of making a sprocket, the method comprising cutting a disc sprocket from a metal plate using a water jet cutter.

2. The method of claim 1 further comprising:
cutting a second disc sprocket from a metal plate using a water jet cutter; and
assembling the second disc sprocket with the disc sprocket to form a sprocket.

3. The method of claim 2, wherein the second disc sprocket is cut from the same metal plate as the disc sprocket.

4. The method of claim 2, wherein the second disc sprocket is assembled with the disc sprocket with fasteners.

5. The method of claim 2 further comprising:
cutting an inner diameter of the disc sprocket; and
cutting an inner diameter of the second disc sprocket that is different than the inner diameter of the disc sprocket.

6. The method of 1, further comprising installing a hub on the disc sprocket.

7. The method of any of the previous claims, wherein the water jet cutter comprises abrasive.

8. The method of claim 7, wherein the abrasive is suspended in a fluid.

9. The method of claim 1 further comprising modifying a surface finish of the disc sprocket.

10. The method of claim 9, wherein modifying a surface finish of the disc sprocket comprises tumbling the disc sprocket.

11. The method of claim 9, wherein modifying a surface finish of the disc sprocket comprises blasting the disc sprocket.

12. A sprocket comprising a metal, planar, annular body with radially outwardly extending teeth, with no thermal stress evident in the annular body.

13. The sprocket of claim 12 comprising only one metal, planar, annular body with radially outwardly extending teeth.

14. The sprocket of claim 13 further comprising a hub.

15. The sprocket of claim 12 comprising multiple metal, planar, annular bodies with radially outwardly extending teeth.

16. The sprocket of claim 15 further comprising a taper lock bushing.

17. The sprocket of claim 16 further comprising a hub.
